(19) United States
(12) Patent Application Publication
(10) Pub. No.: US 2025/0187498 A1
(43) Pub. Date: Jun. 12, 2025

(54) DRIVE MODULE, LONGITUDINAL ADJUSTMENT DEVICE AND VEHICLE SEAT

(71) Applicant: Adient US LLC, Plymouth, MI (US)

(72) Inventors: Ingo QUAST, Düsseldorf (DE); Erik SPRENGER, Wermelskirchen (DE)

(21) Appl. No.: 18/971,267

(22) Filed: Dec. 6, 2024

(30) Foreign Application Priority Data
Dec. 8, 2023 (EP) 23 215 257.9

(51) Int. Cl. B60N 2/02; B60N 2/07; F16H 19/04; F16H 57/02; F16H 57/021

(52) U.S. Cl. CPC B60N 2/02253; B60N 2/0722; F16H 19/04; F16H 57/021; F16H 2019/046; F16H 2057/02034; F16H 2057/02082

(57) ABSTRACT

A drive module may have a drive unit having a single drive motor which may have a drive shaft having a plurality of shaft portions, having at least one drive gear which for movement is coupled to a first shaft portion. The drive module may also have at least one gear unit and at least one overload element. The as least one overload element is coupled to a second shaft portion. The gear unit couples the first shaft portion to the drive gear, and the second shaft portion to the overload element.

### FIELD

The invention relates to a drive module for a longitudinal adjustment device of a vehicle seat, and to such a longitudinal adjustment device and to a vehicle seat.

### BACKGROUND

A longitudinal adjustment device generally comprises two pairs of rails which are disposed so as to be mutually spaced apart and are in each case constructed from two rails, one upper rail assigned to the seat and one lower rail assigned to the floor of a vehicle. The longitudinal adjustment device moreover comprises at least one spring-loaded movable locking part which is mounted on the upper rail and in a locking position blocks any movement of the upper rail in the lower rail. The lower rail here can have cut-outs, while the upper rail is provided with openings, and the locking part on its two mutually opposite longitudinal sides supports projections which, in the locking position, are movable into the openings as well as into the cut-outs by a spring. A longitudinal adjustment device of this type is known, for example, from the European patent EP 1 227 950 B1.

The invention is based on the object of improving a drive module of the type mentioned at the outset, in particular of providing a compact drive module having at least two functions, a longitudinal adjustment device having such an improved drive module, and a corresponding vehicle seat.

The first object mentioned is achieved according to the invention by a drive module having the features of claim 1. The second object mentioned is achieved according to the invention by a longitudinal adjustment device having the features of claim 10. The third object mentioned is achieved according to the invention by a vehicle seat having the features of claim 15.

Advantageous design embodiments which may be used individually or in mutual combination are the subject matter of the dependent claims.

The drive module according to the invention for a longitudinal adjustment device of a seat, in particular of a vehicle seat, comprises a drive unit having at least a single drive motor which comprises a drive shaft having a plurality of shaft portions, and having at least one drive gear which for movement is coupled to a first shaft portion of the drive shaft. The drive module furthermore comprises at least one gear unit and at least one overload element which for movement is coupled to a second shaft portion of the drive shaft. The gear unit couples the first shaft portion to the drive gear, and the second shaft portion to the overload element.

Owing to the fact that the drive module has two shaft portions, this drive module, in addition to the drive, can also ensure an overload function, as opposed to the prior art. In other words: the drive module is designed as a multi-function drive module which comprises the at least one drive gear for moving the upper rail relative to the lower rail, and the at least one overload element for reliably establishing or fixing the upper rail and the lower rail to one another in the event of an overload, in particular in the event of an accident.

For example, the drive unit can be designed as a rack drive. For example, the overload element can be designed as a locking mechanism. In this way, the drive module combines a drive unit which has a single drive motor and is designed as a rack drive with an overload element which is designed as a locking mechanism. As a result, the drive module is of a compact and simple design and enables the use of small drive motors in contrast to the solutions having known trapezoidal spindles and the known large high-torque drive motors.

The drive module can in particular comprise a housing (also referred to as gear unit housing) in which the gear unit is disposed and on which at least partially on the outside the drive wheel is mounted so as to be freely movable and the overload element is mounted so as to be freely movable. In particular, the overload element protrudes only partially from the housing. In contrast, the drive wheel is mounted completely on the outside so as to be movable on the housing. Moreover, the housing can in regions have a support extension which has a contact face for receiving and arranging the drive motor. The housing in particular has a support extension which is co-aligned with a housing base. The support extension extends in particular in the longitudinal direction of the housing and away from the latter, in particular away from the housing base. The support extension can also be referred to as the housing base extension. The support extension can be designed as a profile, for example, in particular as a bowl-shaped profile.

The housing on a longitudinal side can have at least one first clearance for the drive gear, in particular a drive pinion, and at least one second clearance for the overload element. The first clearance can in particular be specified to receive a drive interface. The drive interface is in particular specified for a form-fitting connection to the drive gear. The first clearance can be designed, for example, as a passage opening, in particular a round hole, in which the drive interface is mounted with play and so as to be movable, in particular rotatable.

The second clearance can in particular be specified to mount an overload element, which is designed as a locking worm, for example, so as to be freely movable. For example, the second clearance can be designed as an elongate bore which extends in the longitudinal direction of the housing.

In addition, the housing on an upper side can have at least one bearing clearance. The bearing clearance can be designed, for example, for receiving and movably mounting at least one pre-loading element, in particular at least one pre-loading spring. The pre-loading element can be disposed between the housing base of the housing and a lower side of the upper rail. The pre-loading element herein can extend from the housing base through the housing, and out of the bearing clearance, in the direction of the lower side of the upper rail.

The drive motor and the housing can be disposed in the longitudinal direction of the drive module and behind one another, for example. In particular, the end sides of the drive motor and of the housing can be mutually contiguous. This enables a particularly narrow and elongate construction of the drive module in such a way that the latter can be disposed and installed completely within the rail assembly.

For example, the housing on at least one of its housing end walls can have at least one shaft clearance. The shaft clearance is specified to receive the drive shaft with play. In this way, the drive shaft can be mounted so as to be freely movable in the housing.

The housing can moreover comprise a central rotary bearing, for example. The central rotary bearing can be designed, for example, as at least one central bearing bushing which protrudes perpendicularly outwards from one of the longitudinal sides of the housing. The central bearing bushing can be designed, for example, as a stationary bearing pin or as a stationary bearing stud which is rotatably mounted on the upper rail, in particular on the insides of the upper rail.

The overload element can be designed, for example, as a locking element, in particular as a locking worm. During normal operation, the overload element is mounted with play relative to the lower rail, and thus without any locking engagement or blocking engagement in the latter.

The longitudinal adjustment device according to the invention comprises the at least one rail assembly having a fixed lower rail and an upper rail which is adjustable relative to the lower rail, and the at least one drive module described above, which is able to be coupled, or is coupled, to the rail assembly. The drive module can be designed as a rack drive. As a result of such a design as a rack drive, additional spindle holders and complex welding operations, and riveting of spindle brackets, are reliably avoided.

Moreover, the drive module can be disposed completely in a cavity formed between the lower rail and the upper rail, and be mounted on the upper rail.

The drive gear here can be disposed without play in at least one tooth element, in particular a toothed strip having a toothing (also referred to as mating toothing) of the lower rail. The mating toothing can be formed on a longitudinal side of the lower rail and thus be integrated in the latter. Alternatively, a separate toothed rail can be disposed as the toothing on the lower rail, or be disposed so as to extend parallel to the latter in the longitudinal direction. As a result of the drive gear, in particular the drive pinion, which engages in the toothing and is driven by the drive motor, the upper rail can be moved and adjusted relative to the lower rail.

The overload element can be disposed with play in at least one tooth element of the lower rail, in particular in a contactless manner in the toothing. In other words: the overload element, for example a locking worm, during normal operation is not in contact with the toothing (also referred to as mating toothing) of the lower rail. The overload element is in particular designed as a worm which is disposed in a contactless manner in a plurality of tooth gaps of the toothing of the lower rail. The number of tooth gaps of the toothing utilized defines in particular a maximum absorbable load of the overload element in the event of an accident (also referred to as the event of a crash) and increases in particular a shearing strain of worm teeth of the overload element.

Furthermore, the housing of the drive module can be mounted so as to be pre-loaded relative to the upper rail, and/or rotatably mounted on the upper rail. It can be ensured as a result that the drive gear is disposed without play, and thus has no play in the toothing of the lower rail.

Summarizing, and in other words, the invention provides a drive module which enables the combination of a rack drive and a locking mechanism. The drive module can be installed entirely or completely within the rail assembly, in particular a seat rail (also referred to as the upper rail). Alternatively, the drive motor can be positioned outside the rail assembly, in particular as a function of the motor output. In the case of a small drive motor, the drive module is installed completely in the seat rail. For such a longitudinal adjustment device having such a drive module, a toothing similar to a rack or a toothed strip or a toothed profile, can be directly incorporated in the lower rail. However, the toothing can also be implemented by way of a toothed strip which is connected to the lower rail. The upper rail can have integrated openings, in particular in a rail upper side of the upper rail, for a current connector of the drive module disposed inside the upper rail, in particular of the internal drive motor.

### DESCRIPTION OF THE FIGURES

The invention is explained in more detail hereunder by means of advantageous exemplary embodiments illustrated in the figures. However, the invention is not limited to these exemplary embodiments. In the figures:

FIG. 1: shows a vehicle seat having a longitudinal adjustment device in a schematic illustration;

FIG. 2: shows a perspective illustration of a rail assembly;

FIG. 3: shows a partially sectional perspective illustration of the rail assembly according to FIG. 2, having an internal drive module according to the invention;

FIG. 4: shows a perspective illustration of the drive module according to the invention;

FIG. 5: shows a partially sectional enlarged lateral view of the rail assembly in the region of the internal drive module;

FIG. 6: shows an enlarged lateral view of the rail assembly in the region of the internal drive module having a superimposed force/lever diagram;

FIG. 7: shows a partially sectional end side view of the rail assembly;

FIG. 8: shows an enlarged lateral view of the rail assembly in the region of the internal drive module having a superimposed force diagram;

FIG. 9: shows a perspective illustration of a gear unit of the drive module;

FIG. 10: shows an enlarged perspective illustration of the drive module in the region of the drive gear;

FIG. 11: shows a perspective illustration of a drive worm gear having a drive interface;

FIG. 12: shows an enlarged perspective illustration of the drive module in the region of an overload mechanism, having associated gear stages and overload element;

FIG. 13: shows a perspective illustration of a gear unit member comprising a worm gear and worms for driving the overload elements; and

FIG. 14: shows a sectional illustration of the drive module in the region of the overload element.

### DETAILED DESCRIPTION

Equivalent parts are provided with the same reference signs in all figures.

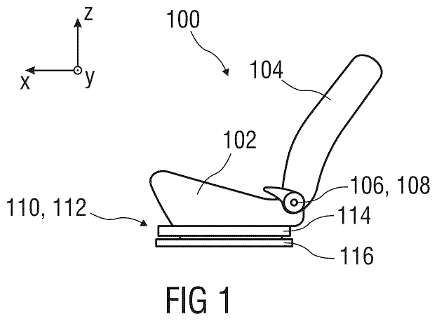

A vehicle seat 100 from the prior art, which is schematically illustrated in FIG. 1, will be described hereunder while using three mutually perpendicular spatial directions. A longitudinal direction x in a vehicle seat 100 installed in the vehicle extends largely horizontally and preferably parallel to a vehicle longitudinal direction, the latter corresponding to the usual direction of travel of the vehicle. A transverse direction y, extending perpendicularly to the longitudinal direction x, is likewise horizontally aligned in the vehicle and extends parallel to a vehicle transverse direction. A vertical direction z extends perpendicularly to the longitudinal direction x and perpendicularly to the transverse direction y. In a vehicle seat 100 installed in the vehicle, the vertical direction z preferably extends parallel to a vehicle vertical axis.

The positional indications and directional indications used, such as front, rear, top and bottom, for example, relate to a viewing direction of a passenger in a normal sitting position in the vehicle seat 100, wherein the vehicle seat 100 is installed in the vehicle and is aligned in the use position suitable for transporting passengers, with an upright backrest 104, and is aligned as customary in the direction of travel. However, the vehicle seat 100 can also be installed or moved in a deviating alignment, for example transversely to the direction of travel. Unless described otherwise, the vehicle seat 100 is constructed so as to be mirror-symmetrical in relation to a plane extending perpendicularly to the transverse direction y.

The backrest 104 can be pivotably disposed on a seat part 102 of the vehicle seat 100. For this purpose, the vehicle seat 100 can optionally comprise a fitting 106, in particular an adjustment fitting, rotary fitting, latching fitting or tumbling fitting.

The positional indications and directional indications used, such as radial, axial and in the circumferential direction, for example, relate to a rotation axis 108 of the fitting 106. Radial means perpendicular to the rotation axis 108. Axial means in the direction of or parallel to the rotation axis 108.

The vehicle seat 100 can optionally comprise a longitudinal adjustment device 110. The longitudinal adjustment device 110 comprises, for example, a rail assembly 112 having a first rail element 114 and a second rail element 116.

The first rail element 114 is adjustable in the longitudinal direction x relative to the second rail element 116. The first rail element 114 is fastened to the seat part 102. The second rail element 116 is fastened to a structural element of a vehicle, for example a vehicle floor.

For improved clarity, the first rail element 114 is referred to as the upper rail 114 in the description hereunder. This upper rail 114 (also referred to as the running rail or slide) is assigned to the vehicle seat 100 and is specified to support this vehicle seat 100. The second rail element 116 is referred to as the lower rail 116 hereunder. The lower rail 116 is fixed, and by way of example connected to the floor of a vehicle.

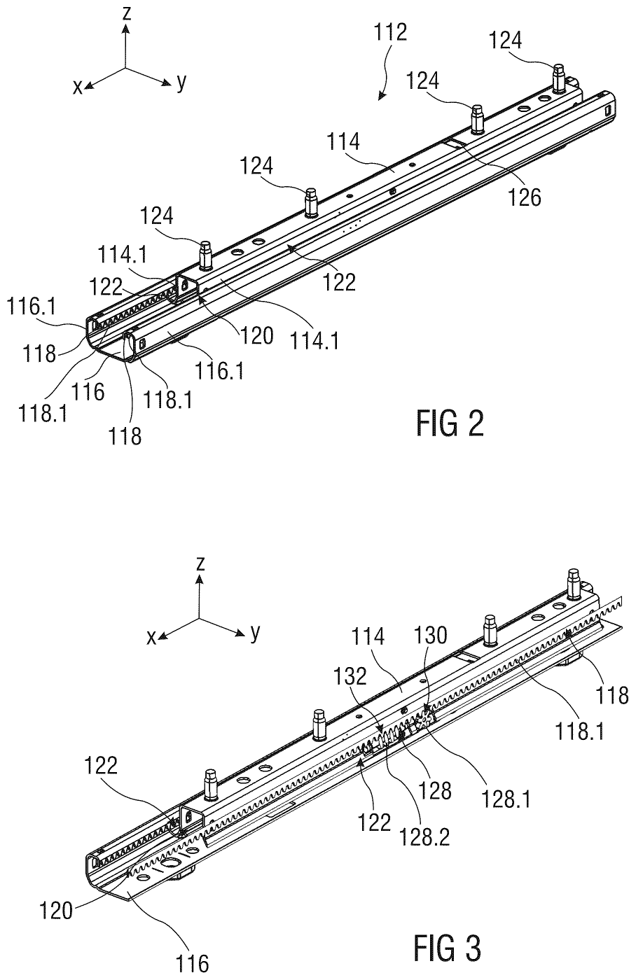

FIG. 2 shows a perspective illustration of the rail assembly 112.

The rail assembly 112 comprises the upper rail 114, which is movable in the longitudinal direction x, and the stationary lower rail 116. The two rails 114, 116 are mutually disposed in such a manner that a cavity 120 between those is formed at least in an overlapping region of the two rails 114, 116.

The two rails 114, 116 are designed, for example, as U-shaped rail profiles, the longitudinal sides 114.1, 116.1 of the latter engaging behind one another. For example, leg ends of the longitudinal sides 114.1, 116.1 of the upper rail 114 and of the lower rail 116 can be bent at least once or multiple times in such a manner that they engage behind one another.

When viewed in the longitudinal direction x, two lateral internal interaction regions 122 can be formed between the lower rail 116 and the upper rail 114.

The upper rail 114 can be fastened to the seat part 102 (illustrated in FIG. 1) by means of fastening elements 124.

Moreover, the upper rail 114 can comprise at least one connector opening 126 for a supply connector not illustrated, in particular a current connector and/or a line connector.

A tooth element 118 can be provided for a longitudinal adjustment of the upper rail 114 relative to the lower rail 116. The tooth element 118 extends in the longitudinal direction x on one of the insides of the longitudinal sides 116.1, or on both insides of the longitudinal sides 116.1, of the lower rail 116. In other words: the lower rail 116 comprises on one side or on both sides, on the inside on its longitudinal sides 116.1, in each case one tooth element 118. In particular, the tooth element 118 extends over the entire length of the lower rail 116.

The tooth element 118 can be incorporated, for example, directly as a toothing 118.1 in the lower rail 116, in particular on a free leg end of the lower rail 116 that is bent inwards. The toothing 118.1 functions in the manner of a rack. Alternatively, the tooth element 118 can be designed as a separate toothed strip which is connected to the lower rail 116.

FIG. 3 shows a partially sectional perspective illustration of the rail assembly 112 according to FIG. 2, having an internal drive module 128 according to the invention.

The drive module 128 is disposed in the cavity 120 formed between the lower rail 116 and the upper rail 114, and is mounted on the upper rail 114. In particular, the drive module 128 is designed in such a manner that it is disposed completely in the cavity 120, in particular completely in a rail cavity of the upper rail 114.

The drive module 128 comprises at least one drive gear 128.1 and at least one overload element 128.2.

One drive gear 128.1 and one overload element 128.2 can in each case be disposed in at least one, or in both, lateral internal interaction region/regions 122 extending in the longitudinal direction x between the lower rail 116 and the upper rail 114.

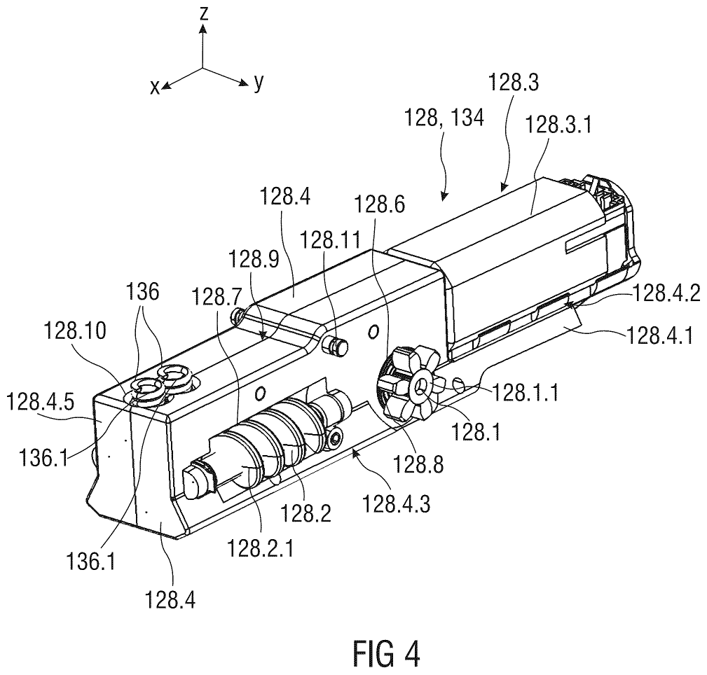

For the longitudinal adjustment of the upper rail 114 relative to the lower rail 116, the drive gear 128.1, which is designed as a drivable pinion 128.1.1 (illustrated in FIG. 4) for example, is in a meshing engagement 130 with the tooth element 118, in particular with the toothing 118.1 in or on the lower rail 116. In the process, the drive gear 128.1 engages in the toothing 118.1 (also referred to as the mating toothing) without play, i.e. without play perpendicular to the longitudinal direction x, in particular in the vertical direction z, and is thus in contact with the toothing 118.1. As a result, a reliable meshing engagement 130 between the drive gear 128.1 and the toothing 118.1 is effected in such a way that the upper rail 114 can be moved and adjusted in the longitudinal direction x relative to the lower rail 116. In other words: free play in the longitudinal direction is avoided by the meshing engagement 130. For this purpose, the pinion 128.1.1 is impinged with a spring against the tooth element 118, the latter being designed as a rack or toothed strip, for example.

In contrast, the overload element 128.2 is disposed in the toothing 118.1 of the lower rail 116 with play 132 in the vertical direction z and in the longitudinal direction x. This means: the overload element 128.2 is not in contact with the toothing 118.1. The overload element 128.2 serves to ensure an overload function on the drive module 128. The overload element 128.2 serves in particular to reliably establish or fix the upper rail 114 and the lower rail 116 to one another in the event of an overload, in particular in the event of an accident. The overload element 128.2 can be designed as a locking worm 128.2.1, for example.

The drive module 128 can primarily comprise one or a plurality of drive gears 128.1, in particular drive gear wheels or pinions 128.1.1. For example, the drive module 128 can comprise two drive gears 128.1 which lie opposite one another and are mutually spaced apart. The two drive gears 128.1 in the mutually opposite interaction regions 122 are in each case in a meshing engagement 130 with the toothings 118.1 on the lower rail 116.

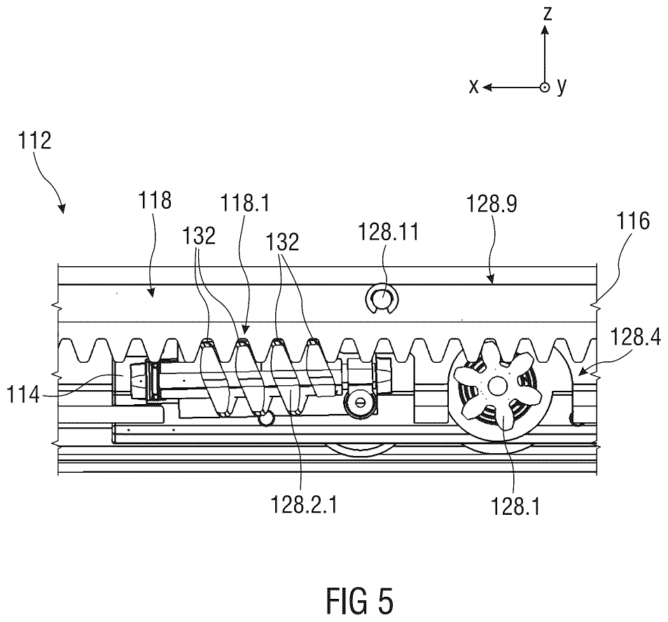

The drive module 128 can furthermore comprise one or a plurality of overload elements 128.2, in particular two locking worms 128.2.1. For example, the locking worms 128.2.1 can lie opposite one another and be mutually spaced apart. The two locking worms 128.2.1, in particular their helical worm, in the mutually opposite interaction regions 122 are in each case disposed with play 132 in the toothings 118.1 on the lower rail 116, as is shown in detail in FIG. 5.

FIG. 4 shows a perspective illustration of the drive module 128 according to the invention. The drive module 128 is designed as a multifunction drive module which comprises at least the one drive gear 128.1 for longitudinal adjustment, and the at least one overload element 128.2 for ensuring the overload function.

The drive module 128 comprises a drive unit 128.2 having at least one single drive motor 128.3.1. The drive unit 128.3 can be designed as a rack drive, for example. The overload element 128.2 can be designed as a locking mechanism, for example.

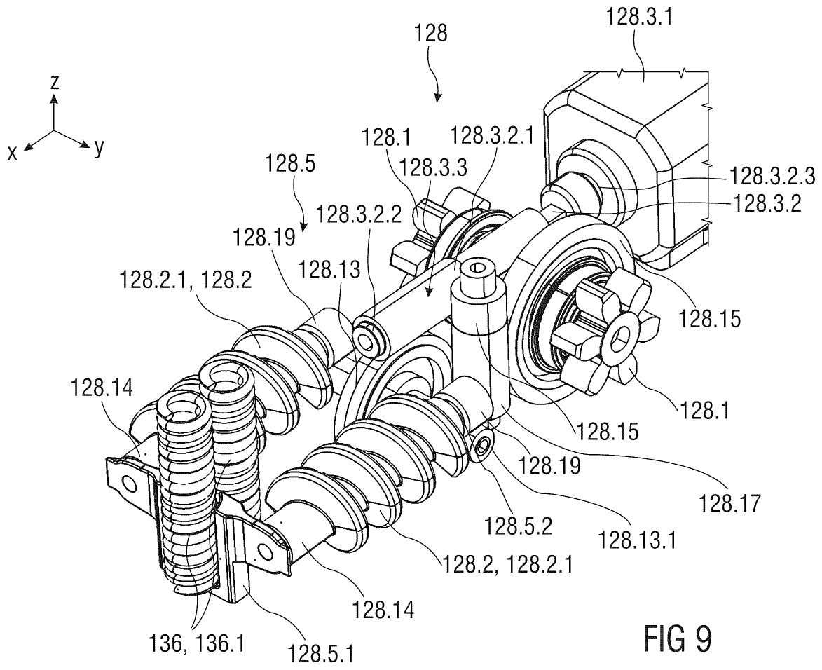

The drive module 128 comprises at least the drive unit 128.2 having the drive motor 128.3.1 and the at least one drive gear 128.1, at least one gear unit 128.5 (illustrated in FIG. 9), and the at least one overload element 128.2 and a housing 128.4 in which at least the gear unit 128.5 is disposed.

All components of the drive module 128 can be pre-assembled so as to form a pre-assembly module 134.

The drive module 128 combines the drive unit 128.3, designed as a rack drive, having the single drive motor 128.3.1 with the overload element 128.2 which in the event of an overload acts as a locking mechanism, for example.

The drive gear 128.1 as well as the overload element 128.2 are mounted at least partially on the outside so as to be freely movable on the housing 128.4. In particular, the overload element 128.2, which is designed as an elongate locking worm 128.2.1, for example, protrudes only partially from the housing 128.4. In contrast, the drive gear 128.1, which is designed as a driveable pinion 128.1.1, for example, is mounted, completely on the outside so as to be movable on the housing 128.4.

The housing 128.4 can moreover in regions comprise a support extension 128.4.1 which has a contact face 128.4.2 for receiving and arranging the drive motor 128.3.1.

The support extension 128.4.1 is in particular disposed so as to be co-aligned with a housing base 128.4.3. The support extension 128.4.1 extends in particular in the longitudinal direction x of the housing 128.4 and away from the latter, in particular away from the housing base 128.4.3. The support extension 128.4.1 can also be referred to as the housing base extension. The support extension 128.4.1 is designed as a profile, in particular as a bowl-shaped profile, for example.

The housing 128.4 can be formed in multiple parts, in particular two parts, for example from two assembled housing halves 128.4.4 and 128.4.5.

The housing 128.4 on a longitudinal side can have at least one first clearance 128.6 for the drive gear 128.1, and at least one second clearance 128.7 for the overload element 128.2.

The first clearance 128.6 can in particular be specified to receive a drive interface 128.8. The drive interface 128.8 (also shown in FIG. 11) is in particular specified for a form-fitting connection to the drive gear 128.1. The first clearance 128.6 can be formed as a passage opening, in particular a round hole, for example, in which the drive interface 128.8 is mounted with play and so as to be movable, in particular rotatable.

The second clearance 128.7 can in particular be specified to mount the overload element 128.2 so as to be freely movable, the latter being designed as a locking worm 128.2.1, for example. For example, the second clearance 128.7 can be designed as an elongate bore which extends in the longitudinal direction x of the housing 128.4.

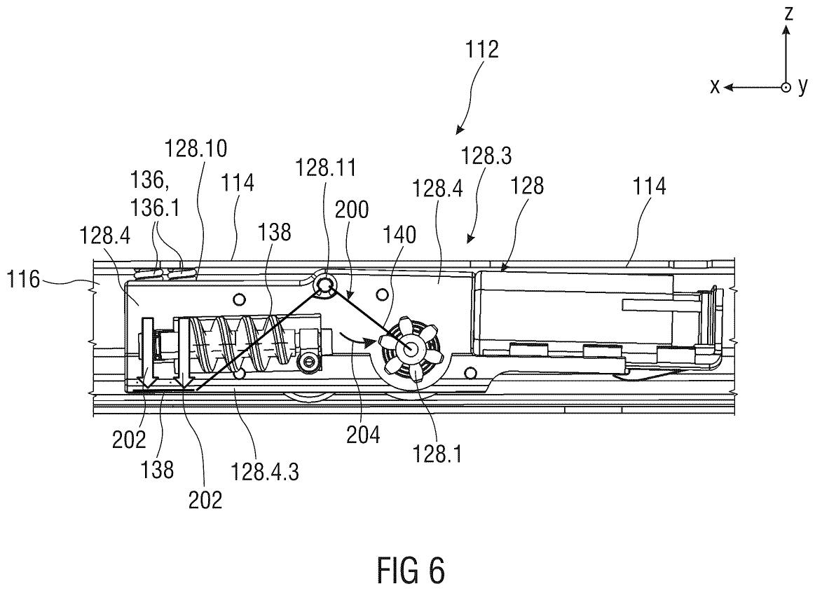

Additionally, the housing 128.4 on an upper side 128.9 can have at least one bearing clearance 128.10. The bearing clearance 128.10 can be designed, for example, to receive and movably mount at least one pre-loading element 136, in particular at least one pre-loading spring 136.1. The pre-loading element 136 can be disposed between the housing base 128.4.3 of the housing 128.4 and a lower side of the upper rail 114, as is illustrated in FIG. 6.

The drive motor 128.3.1 and the housing 128.4 for the gear unit 128.5 can be disposed in the longitudinal direction x of the drive module 128 and behind one another, for example. In particular, end sides of the drive motor 128.3.1 and of the housing 128.4 can be mutually contiguous. In particular, the end sides are designed so as to correspond to one another in such a way that they bear on one another.

Moreover, a housing of the drive motor 128.3.1 and the housing 128.4 on their housing end walls disposed towards one another can have a shaft clearance 128.3.2.3 (in an exemplary manner for the housing end wall of the drive motor 128.3.1 illustrated in FIG. 9).

Moreover, the housing 128.4 can comprise a central rotary bearing 128.11, for example. The central rotary bearing 128.11 can be designed as at least one central bearing bushing 128.12 (illustrated in FIG. 8), for example, which protrudes perpendicularly outwards from one of the longitudinal housing sides of the housing 128.4. The central bearing bushing 128.12 can be designed, for example, as a stationary bearing pin or a stationary bearing stud which is rotatably mounted on the upper rail 114, in particular on insides of the upper rail 114.

The drive module 128 in FIG. 4 is illustrated as a pre-assembly module 134 having the components which are substantially identifiable from the outside, i.e. the pre-loading elements 136, the overload elements 128.2, the drive gear 128.1, and the drive motor 128.3.1 in the assembled state. The drive motor 128.3.1 by way of internal gear unit components (illustrated in FIG. 9) drives the drive gear 128.1 or the drive gears 128.1 (also referred to as drive gear wheel/drive gear wheels). Furthermore, the locking worm/worms 128.2.1 is/ae driven by way of further gear unit components. A gearing ratio here is chosen in such a way that the locking worm 128.2.1, which lies in the tooth gaps of the toothing 118.1 (illustrated in FIG. 3) of the tooth element 118 (illustrated in FIG. 3) is moved at the same speed directed in x as the drive gear 128.1. It can be ensured in this way that the locking worm 128.2.1 during normal operation of the upper rail 114 (illustrated in FIG. 3) never comes into contact with the toothing 118.1. This locking worm 128.2.1 can be kept ready exclusively for high loads in the event of an accident, and can be provided for a safety engagement for blocking the upper rail 114 and the lower rail 116 (illustrated in FIG. 3) in the event of an accident.

The housing 128.4 can be, for example, a metal housing or else a metal-reinforced plastics material housing. The pre-loading springs 136.1 serve in particular for providing a contact pressure of the drive gear 128.1 or of the drive gears 128.1, so that the latter achieve a play-free and thus meshing engagement 130 with the toothing 118.1 for the longitudinal adjustment of the upper rail 114 relative to the lower rail 116, as is shown in FIG. 3.

FIG. 5 shows a partially sectional enlarged lateral view of the rail assembly 112 in the region of the internal drive module 128.

The rotary bearing 128.11 is disposed on the housing longitudinal sides so as to be centric and below the upper side 128.9 of the housing 128.4.

The drive gear 128.1 is pressed into the toothing 118.1 without play. The locking worm 128.2.1 is disposed with the play 132, in particular in the vertical direction z and/or in the longitudinal direction x, and thus in a contactless manner, within the tooth gaps of the toothing 118.1. The length of the locking worm 128.2.1 can be determined, for example, as a function of the number of tooth gaps of the toothing 118.1 and/or as a function of a maximum shear force in the event of a high load in an accident or a crash. In particular, the length of the locking worm/worms 128.2.1 can be adapted as a function of the length and/or of so-called “load classes” of the rails 114, 116.

FIG. 6 shows an enlarged lateral view of the rail assembly 112 in the region of the drive module 128, which is internal in the upper rail 114, having a superimposed force/lever diagram 200.

The drive gear 128.1 by way of the spring force of the pre-loading spring/springs 136.1 is pressed without play into the toothing 118.1 (illustrated in FIG. 5).

In the process, the pre-loading element 136 can extend from the housing base 128.4.3, through the housing 128.4 and out of the bearing clearance 128.10, in the direction of the lower side of the upper rail 114.

The pre-loading springs 136.1 ensure the absence of play from the rack drive, in particular from the drive gear 128.1 in the toothing 118.1 (illustrated in FIG. 5). The pre-loading springs 136.1, by way of a force according to arrow 202, put pressure on a facing lever 138 having a pivot point in the central rotary bearing 128.11, and transmit a resultant torque according to arrow 204 to a lever 140, which faces away, between the pivot point of the central rotary bearing 128.11 and a drive pivot point of the drive gear 128.1.

Moreover, it can be ensured by way of the spring loading caused by means of the pre-loading springs 136.1 that the drive gear 128.1 in the event of an overload acting on the rail assembly 112, in particular in the vertical direction z, is pressed out of the toothing 118.1 (also referred to as the mating toothing). In the process, the entire drive unit 128.3, in particular the drive housing 128.4, rotates about the pivot point in the central rotary bearing 128.11. The extracting force is caused by way of a flank angle of the drive unit 128.3 which is designed as a rack drive.

The one locking worm, or the plurality of locking worms 128.2.1 (illustrated in FIG. 5) is/are likewise located within the toothing 118.1. The locking worm 128.2.1 can be designed as a single-start or a multiple-start worm having one or a plurality of screw threads. The respective screw thread of the locking worm 128.2.1 can lie with the play 132 (illustrated in FIG. 5) within the tooth gaps of the toothing 118.1 (also referred to as the drive toothing), and thus be contactless and without contact with the toothing 118.1. Other designs of locking elements are possible.

A load or force acting in the longitudinal direction x can cause the extracting force on the drive gear 128.1, which acts in the vertical direction z, by way of a corresponding engagement angle of, for example, 20°. During this movement, the drive gear 128.1 is moved along the inclined tooth flanks of the toothing 118.1. In the process, the upper rail 114 already travels a longitudinal distance in the longitudinal direction x.

The locking worm 128.2.1 in the case of the forces arising in a crash moves by way of this longitudinal distance in the longitudinal direction x, on the one hand, and moreover towards the toothing 118.1, due to the rotation of the drive unit 128.3 about the pivot point in the central rotary bearing 128.11, until contact is established and a locking engagement between the locking worm 128.2.1 and the toothing 118.1 occurs.

The respective locking worm 128.2.1 can be conceived to be in contact with the toothing 118.1 (also referred to as the drive toothing) in a self-locking manner, for example due to a corresponding mounting and a corresponding worm pitch. The load of the crash here in is transmitted from the upper rail 114 by way of the locking worm/worms 128.2.1 to the lower rail 116.

The locking worm 128.2.1 and the toothing 118.1, designed as a mating toothing, form a locking unit in the event of a crash.

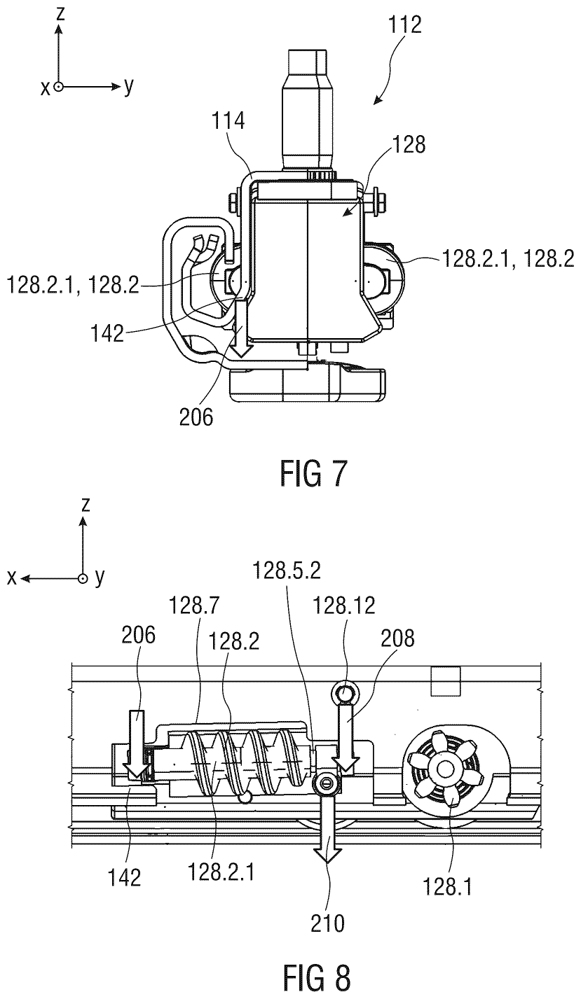

FIG. 7 shows a partially sectional end side view of the rail assembly 112. FIG. 8 shows an enlarged lateral view of the rail assembly 112 according to FIG. 7 in the region of the internal drive module 128, having superimposed forces according to arrows 206 to 210.

In the event of an accident, high vertical forces acting in the vertical direction z on the rail assembly 112 (illustrated in FIG. 7), in particular on the upper rail 114 (illustrated in FIG. 7), can be discharged according to arrow 206 directly by way of a z-detent 142 in the upper rail 114, and according to arrow 208 directly by way of the bearing bushing 128.12, and according to arrow 210 by way of a bearing element 128.5.2 (illustrated inter alia in FIG. 8), for example a journal bearing. The respective locking worm 128.2.1 protrudes from the associated second clearance 128.7 and in each case into the upper rail profile of the upper rail 114.

FIG. 9 shows a perspective illustration of the gear unit 128.5 of the drive module 128.

The shaft clearance 128.3.2.3 is specified to receive with shaft play a drive shaft 128.3.2 which emanates from the drive motor 128.3.1. In this way, the drive shaft 128.3.2 can be mounted so as to be freely movable in the housing 128.4 (illustrated in FIG. 4).

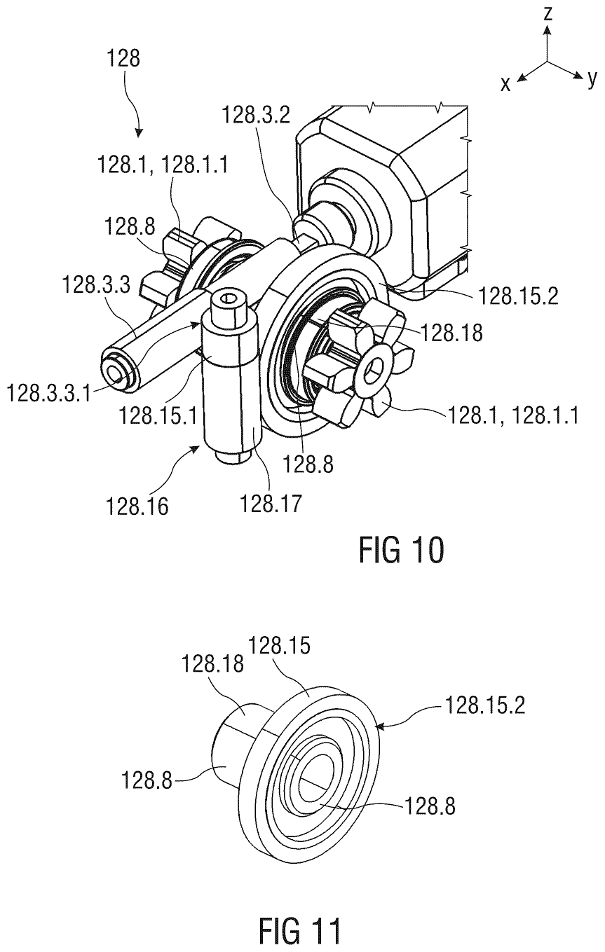

The gear unit 128.5 can comprise a plurality of, preferably at least two, gear stages. The overall gear ratios between the drive unit 128.3 (illustrated in FIG. 6), i.e. from the drive motor 128.3.1 to the drive gear 128.1 designed as a pinion 128.1.1 (illustrated in FIG. 10), and the locking unit. i.e. from the drive motor 128.3.1 to the locking worms 128.2.1, are mutually adapted in such a way that the linear propulsion movement of the pinion 128.1.1 takes place at the same speed as the propulsion movement of the locking worm 128.2.1, wherein the locking worm 128.2.1 does not drive but simply runs conjointly in a contactless manner in the toothing 118.1 (illustrated in FIG. 5) as described above. The same speed is required so that there is never any contact between the overload element 128.2 (also referred to as the locking element), in particular the locking worm 128.2.1, and the toothing 118.1 during a normal longitudinal adjustment of the seat. Locking engagement takes place only in the event of an accident, and thus in the event of an acting overload.

The drive shaft 128.3.2 can have a plurality of shaft portions 128.3.2.1, 128.3.2.2. The respective drive gear 128.1 for movement is coupled to the first shaft portion 128.3.2.1.

The respective overload element 128.2 for movement is coupled to the second shaft portion 128.3.2.2.

The gear unit 128.5 couples the first shaft portion 128.3.2.1 to the drive gears 128.1, and the second shaft portion 128.3.2.2 to the overload elements 128.2.

Thus, the drive module 128 combines the drive unit 128.3, which is designed as a rack drive having the single drive motor 128.3.1, to the overload elements 128.2, which are designed as a locking mechanism or as a locking unit.

The drive unit 128.3 comprises a drive worm 128.3.3 which is attached to the drive shaft 128.3.2, in particular press-fitted to the latter, in a form-fitting manner.

The drive worm 128.3.3 for a longitudinal adjustment is operatively connected to a worm gear unit consisting of two output worm gears 128.15 which are mutually perpendicular and are operatively connected to the pinions 128.1.1.

The gear unit 128.5 comprises bearing elements 128.5.1, 128.5.2 for the overload elements 128.2. A first bearing element 128.5.1 for the two overload elements 128.2 can simultaneously be designed as a support bearing for the pre-loading element/elements 136, in particular the pre-loading spring/springs 136.1. A second bearing element 128.5.2, which in the longitudinal direction x lies opposite the first bearing element 128.5.1, can be designed as a journal bearing for the overload elements 128.2, for example. The bearing elements 128.5.1 and 128.5.2 keep the overload elements 128.1, 128.2 in position. The housing 128.4 can in particular be a diecast housing, for example a zinc diecast housing.

The overload worm gear 128.13 is mounted at two points in the housing 128.4. Two secondary worms 138.13.1, 128.13.2 (illustrated in FIG. 13) which are in a meshing engagement with the worm gears 128.19 of the overload elements 128.1, 128.2, are disposed on the overload worm gear 128.13.

When viewed in the longitudinal direction x, the respective overload element 128.2, in particular the respective locking worm 128.2.1, on the end that faces away from the drive motor 128.3.1, have in each case corresponding bearing bushings 128.14, and on the end that faces the drive motor 128.3.1, have in each case worm gears 128.19.

FIG. 10 shows an enlarged perspective illustration of the drive module 128 in the region of the drive gears 128.1.

First next thereto is the drive unit 128.3 (illustrated in FIG. 4). The drive worm 128.3.3 is press-fitted onto the drive shaft 128.3.2, or is connected to the latter in a form-fitting manner.

A first worm portion 128.3.3.1 of this drive worm 128.3.3 is operatively connected to a first output worm gear 128.15.1. This first output worm gear 128.15.1 can be part of a gear unit element 128.16 which combines this first output worm gear 128.15.1 with an additional worm 128.17. This additional worm 128.17 in turn drives a second output worm gear 128.15.2 which transmits the movement to the drive gears 128.1 designed as pinions 128.1.1.

For this purpose, the second output worm gear 128.15.2 possesses the drive interface 128.8, for the form-fitting connection, for example, to the pinions 128.1.1 (also referred to as the drive pinions).

FIG. 11 shows a perspective illustration of one of the output worm gears 125.15, in particular of the second output worm gear 128.15.2 having the drive interface 128.8.

The high bearing forces acting by way of the pre-loading springs 136.1 (illustrated in FIG. 9) on the pinions 128.1.1 (illustrated in FIG. 9) in the drive module 128 are received by additional bearing bushings 128.18. Alternatively, ball bearings can be provided instead of the additional bearing bushings 128.18 in order to further increase efficiency. The additional bearing bushings 128.18 for the drive gears 128.1 (illustrated in FIG. 3) and the bearing bushings 128.12 (illustrated in FIG. 8) for the locking worms 128.2.1 (illustrated in FIG. 4) can in each case be designed as plastics material bearing bushings.

The gear unit 128.5 (illustrated in FIG. 9) having the drive worm 128.3.3 (illustrated in FIG. 9), designed as an additional worm gear or as a worm, and the output worm gears 128.15 interacting therewith and the additional worm 128.17 (illustrated in FIGS. 9 and 10) can have a gear ratio of i=115, for example.

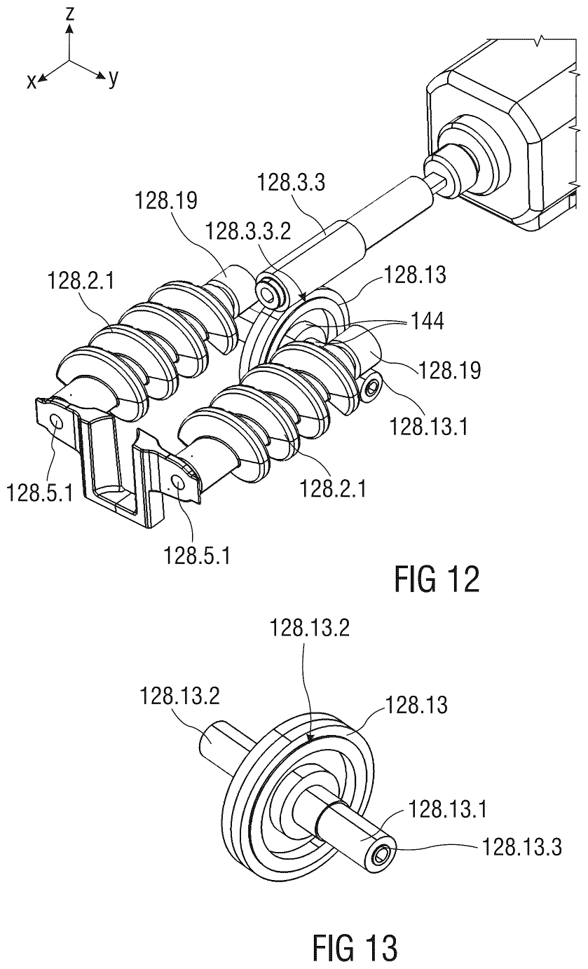

FIG. 12 shows an enlarged perspective illustration of the drive module 128 (illustrated in FIG. 4) in the region of an overload mechanism having associated gear stages and of the overload element 128.2 (illustrated in FIG. 4). FIG. 13 shows a perspective illustration of a gear unit member comprising the overload worm gear 128.13 and worm gears 128.19 for driving the overload elements 128.1, 128.2, designed as locking worms 128.2.1.

The drive of the locking elements designed, for example, as locking worms 128.2.1 (illustrated in FIG. 4) or overload elements 128.2 (illustrated in FIG. 3), which run in a contactless manner within the toothing 118.1 (illustrated in FIG. 3) takes place by way of gear unit members. The overall ratio between the drive shaft 128.3.2 and the locking worm axles can be i=192, for example. This overall ratio, conjointly with the pitch of the locking worms 128.2.1, enables the synchronous screw movement of the locking worms 128.2.1 which is adapted to the pinions 128.1.1 (illustrated in FIG. 9).

The drive worm 128.3.3 (illustrated in FIG. 9) which is connected to the drive shaft 128.3.2 (illustrated in FIG. 9) possesses a second worm portion 128.3.3.2 (illustrated in FIG. 12) which is in contact with the overload worm gear 128.13. The worm tooth geometry for both worm gears. i.e. the drive worm 128.3.3 (also referred to as the drive worm gear) and the overload worm gear 128.12 is preferably identical. This is again a combined gear unit element which is formed, for example, from the drive worm 128.3.3 and the aforementioned overload worm gear 128.13 and from secondary worms 128.13.1 and 128.13.2 which are situated to the left and the right.

The two secondary worms 138.13.1, 128.13.2, which are in a meshing engagement with the worm gears 128.19 of the overload elements 128.1, 128.2 (illustrated in FIG. 9), are disposed on the overload worm gear 128.13. The overload mechanism has two mountings. A first mounting 128.13.2 is provided for the overload worm gear 128.13 per se, which is in a meshing engagement with the drive worm 128.3.3 (illustrated in FIG. 9), and a second mounting 128.13.3 is provided for the secondary worms 128.13.1 and 128.13.2, which are in a meshing engagement with the worm gears 128.19 (illustrated in FIG. 9).

An ideal axial spacing between the secondary worms 128.13.1 can thus be set by way of the two-point mounting of the overload worm gear 128.13 and the mounting points of the overload elements 128.1, 128.2.

The left-hand and right-hand secondary worms 128.13.1, 128.13.2 transmit their rotating movement to the worm gears 128.19 (illustrated in FIG. 9) of the left and right locking worm 128.2.1 of identical construction. The respective worm gear 128.19 herein can be a direct constituent part of the associated locking worms 128.2.1. The latter can be made, for example, from a steel material or a zinc die cast material. Alternatively, the worm gears 128.19 can in each case be separately designed as an additional part which is fastened to the respective locking worm 128.2.1.

The gear unit 128.5 (illustrated in FIG. 9), and the above-described components thereof, are disposed and mounted directly in the housing 128.4 (illustrated in FIG. 4).

Assembling and mounting the locking worms 128.2.1 in the exemplary embodiment illustrated is enabled by way of the bearing elements 128.5.1, 128.5.2, in particular plastics material bearing elements. The housing 128.4 is in two parts, for example formed from two assembled housing halves 128.4.4 and 128.4.5, as is shown in FIG. 4.

By using the bearing elements 128.5.1, 128.5.2, the housing halves 128.4.4 and 128.4.5 can be of a simple design and produced by simple open-and-shut moulds, in particular as a plastics material housing with metal reinforcements, or as a completely metallic housing, for example made of Zamak. Additional bearing pins can be dispensed with here.

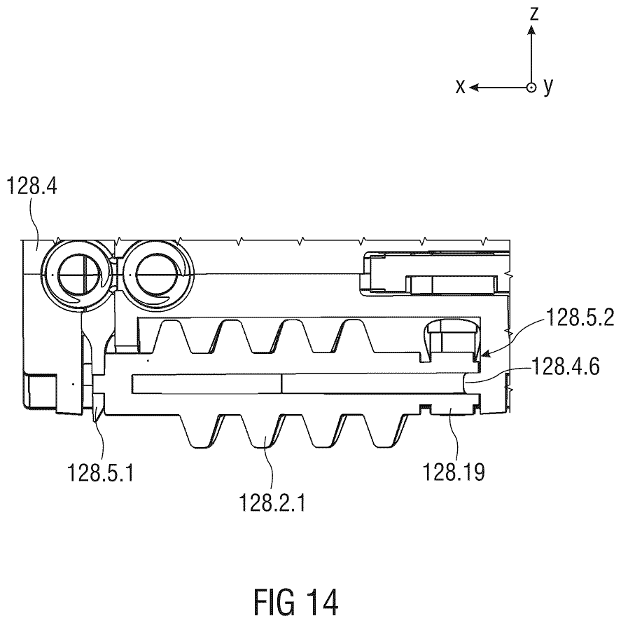

FIG. 14 shows a sectional illustration of the drive module 128 (illustrated in FIG. 3) in the region of the overload element 128.2 (illustrated in FIG. 3).

On the side that faces the worm gears 128.19, the locking worm 128.2.1 is mounted directly in the housing 128.4; provided for this purpose as a second bearing element 128.5.2 is a bearing appendage 128.4.6 on the respective housing half 128.4.4, 128.4.5 of the housing 128.4; illustrated in FIG. 4.

When pre-assembling the respective housing halves 128.4.4 and 128.4.5, the locking worms 128.2.1 are first positioned before the bearing appendage 128.4.6 of the second bearing element 128.5.2 and pushed onto the latter and then snapped into the bearing elements 128.5.1, 128.5.2 (illustrated in FIG. 9) at the other end.

The bearing elements 128.5.1, 128.5.2 can be of a delicate embodiment because the forces acting in the bearing points of the locking worms 128.2.1 during normal operation are minor. The high forces in the event of an accident, upon failure of the bearing points, are transmitted by way of the contact between the locking worms 128.2.1 and the housing 128.4.

### LIST OF REFERENCE SIGNS

100 Vehicle seat
102 Seat part
104 Backrest
106 Fitting
108 Rotation axis
110 Longitudinal adjustment device
112 Rail assembly
114 First rail element (upper rail)
114.1 Longitudinal side
116 Second rail element (lower rail)
116.1 Longitudinal side
118 Tooth element
118.1 Toothing (mating toothing)
120 Cavity
122 Interaction region
124 Fastening element
126 Connector opening
128 Drive module
128.1 Drive gear
128.1.1 Pinion
128.2 Overload element
128.2.1 Locking worm
128.3 Drive unit
128.3.1 Drive motor
128.3.2 Drive shaft
128.3.2.1, 128.3.2.2 Shaft portion
128.3.2.3 Shaft clearance
128.3.3 Drive worm
128.3.3.1, 128.3.3.2 Worm portion
128.4 ousing
128.4.1 Support extension
128.4.2 Contact face
128.4.3 Housing base
128.4.4, 128.4.5 Housing half
128.4.6 Mounting appendage
128.5 Gear unit
128.5.1, 128.5.2 Bearing element
128.6 First clearance
128.7 Second clearance
128.8 Drive interface
128.9 Upper side
128.10 Bearing clearance
128.11 Rotary bearing
128.12 Bearing bushing
128.13 Overload worm gear
128.13.1 Secondary worm
128.14 Additional bearing bushing
128.15 Output worm gear
128.15.1 First output worm gear
128.15.2 Second output worm gear
128.16 Gear unit element
128.17 Additional worm
128.18 Additional bearing bushing
128.19 Worm gear
130 Meshing engagement
132 Play
134 Pre-assembly module
136 Pre-loading element
136.1 Pre-loading spring
138 Lever
140 Lever
142 z-detent
200 Force/lever diagram
202 Arrow
204 Arrow
206 Arrow
208 Arrow
210 Arrow
x Longitudinal direction
y Transverse direction
z Vertical direction

What is claimed is:

1. A drive module, comprising:
a drive unit having a single drive motor which comprises a drive shaft having a plurality of shaft portions, having at least one drive gear which for movement is coupled to a first shaft portion;
at least one gear unit; and
at least one overload element which for movement is coupled to a second shaft portion;
wherein the gear unit couples the first shaft portion to the drive gear, and the second shaft portion to the overload element.

2. The drive module according to claim 1, further comprising a housing in which the gear unit is disposed, and on which at least partially on the outside the drive gear is mounted so as to be freely movable and the overload element is mounted so as to be freely movable.

3. The drive module according to claim 2, wherein the housing on a longitudinal side has at least one first clearance for the drive gear, and at least one second clearance for the overload element.

4. The drive module according to claim 2, wherein the housing on an upper side has at least one bearing clearance.

5. The drive module according to claim 2, wherein the drive motor and the housing extend in the longitudinal direction of the drive module and are disposed behind one another.

6. The drive module according to claim 5, wherein the housing on at least one of its housing end walls has at least one clearance for the drive shaft.

7. The drive module according to claim 1, wherein the housing comprises a rotary bearing.

8. The drive module according to claim 7, wherein the rotary bearing is designed as at least one central bearing bushing which protrudes perpendicularly outwards from one of the longitudinal sides of the housing.

9. The drive module according to claim 1, wherein the overload element is designed as a locking worm.

10. A longitudinal adjustment device which comprises at least one rail assembly having a fixed lower rail, and an upper rail which is adjustable relative to the lower rail, and at least one drive module according to claim 1, which is able to be coupled, or is coupled, to the rail assembly.

11. The longitudinal adjustment device according to claim 10, wherein the drive module is disposed completely in a cavity formed between the lower rail and the upper rail, and is mounted on the upper rail.

12. The longitudinal adjustment device according to claim 10, wherein the drive gear is mounted without play in a tooth element of the lower rail.

13. The longitudinal adjustment device according to claim 12, wherein the overload element lies with play in a toothing of the tooth element of the lower rail.

14. The longitudinal adjustment device according to claim 10, wherein a housing of the drive module is pre-loaded relative to the upper rail and/or is rotatably mounted on the upper rail.

15. A vehicle seat having a longitudinal adjustment device according to claim 10.
